(19) United States
(12) Patent Application Publication
(10) Pub. No.: US 2016/0026174 A1
(43) Pub. Date: Jan. 28, 2016

(54) Method for Planning an Object Comprising a Multitude of Single Parts and Subassemblies, Construction Module and Manufacturing System

(71) Applicant: PFW Aerospace GmbH, Speyer (DE)

(72) Inventors: Berthold Eitzenberger, Ludwigshafen (DE); Sandra Rauch, Mannheim (DE); Martin Harder, Speyer (DE)

(21) Appl. No.: 14/809,480

(22) Filed: Jul. 27, 2015

(30) Foreign Application Priority Data
Jul. 28, 2014 (EP) 14002620.4

(51) Int. Cl. G05B 19/4093; G01G 19/00

(52) U.S. Cl. CPC G05B 19/4093; G01G 19/00; G05B 2219/31053

(57) ABSTRACT

A computer implemented method for planning an object which comprises a multitude of single parts and subassemblies, especially an aerospace object, the method comprising: calculating the total weights of the subassemblies and/or of the object on the basis of the data sets of the single parts and the subassemblies, wherein measured weights are used preferably to calculated weights, and calculated weights are used preferably to target weights for the calculation of the total weight(s) of the subassemblies and/or of the object, and calculating and providing the information about the shares of the used weight types in the calculated total weights. The invention further also relates to a manufacturing system and a computer implemented construction module.

The invention relates to a computer implemented method for planning an object which consists of a multitude of single parts, in particular an aerospace object such as an aviation object or a spaceflight object.

Furthermore, the invention relates to a construction module and to a manufacturing system which are particularly adapted for performing the method.

### PRIOR ART

In the production of aerospace objects, some single parts require advance ordering or advance production, for example due to a long production time, whereas others are rapidly available. While a designer is still busy building a model of the aerospace object out of a multitude of single parts and construction groups (subassemblies), some of the single parts and construction groups are typically already ordered, manufactured or assembled.

A concept for the integration of information accumulated during the life cycle of an object is the so-called product life cycle management, which, in the case of pure product development, is sometimes called product data management. In the product life cycle management of the object, said problem occurs when the construction phase and the production phase overlap in time. A data set is generated in the construction phase for each single part, for each subassembly and for the object itself. In the production phase, real single parts and real subassemblies are produced. Said time overlap of the construction phase and the production phase occurs in particular when objects consist of a multitude of single parts. First, the single parts are produced one by one, then they are assembled to subassemblies, and finally they are assembled to form the object. As a result of the already produced single parts and subassemblies, hereinafter called real single parts and subassemblies, the designer faces limitations in the construction phase, i.e. when constructing further single parts and subassemblies.

A specific problem can be found in that—due to cost considerations—some single parts can be manufactured only once. As an example, the use of carbon-fiber-reinforced plastic (CFRP) in the body of an aircraft leads to an immense reduction of weight. However, CFRP has the disadvantage that the respective single part cannot be changed anymore after its production. For example, when a very big or a very expensive CFRP single part is produced, then it must be used in order to remain within cost limits. Potential deficiencies concerning for instance the statics of the respective single part have to be absorbed by means of additional single parts, for example by means of reinforcement parts. Therefore, in many cases, the weight promised to the purchaser, or a given target weight of the object to be produced cannot be kept.

In other cases, it may happen that single parts from different producers do not fit together, thus making changes necessary. Since single parts are usually produced with a certain production tolerance, depending on the different technical facilities of the producers, the subassemblies have to be adapted by the designer. Consequently, the given target weight of the object to be produced may be exceeded.

EP 0 290 809 B1 describes a method for the precise production and assembly of an object with lots of components, for instance an aircraft. First, a data model with a construction definition of the aircraft structure is generated. From this, a model is generated by means of suitable CAD software. At the same time, from the data model a real model is produced by means of automatically driven model building machines. The dimensions of the real model are measured through a theodolite system and compared to the later model. As a result of the comparison, the data model is updated with regard to the real space like parameters of the model parts. Feedback and updates will be repeated after another construction step in which the single parts are assembled and once again after the complete construction. With this method, a complete construction history of all parts and models can be stored.

DE 10 2009 058 802 A1 discloses an application for the combined representation of a real and a virtual model, e.g. of an aircraft, in the context of a simultaneously real and virtual product development. Product information from models stemming from different data base systems is integrated in a real reference model. Differences of desired values and actual values between the real model and the virtual model are depicted, especially differences in position, orientation, height, brightness or colour.

DE 10 2007 015 682 describes a method for generating digital prototypes of complex objects, for instance automobiles, wherein an electronic specification sheet is maintained which specifies the geometrical and function attributes of a vehicle. A program compiles a CAD dataset from these attributes in order to generate a digital prototype. The program also comprises algorithms for calculating a total weight. In the foreground are high production rates and large scale production.

WO 2005/043421 A1 concerns the automatic generation of 3D CAD models of aircraft wherein a complete model is generated from a multitude of single models. From the 3D model, information about the weight is derived and updated after stress analysis.

EP 1 770 618 A1 addresses the problem of reducing the development time for new car models. The involved developer team comprises departments for analysis, test, design, styling, management and planning, each of which must have access to a common data base. The data base comprises car model data. EP 1 770 618 A1, furthermore, describes a computer-aided car planning system, wherein the performance of a car model is evaluated according to customer restrictions on the CAD computer model.

In EP 1 770 618 A1, data from single parts and the subassemblies comprises an indication of their weight. A structural model of the car also comprises information with regard to the columns and surfaces of the car such as steel types, thickness and weight. A total weight is calculated from the individual weights. In the case that a part is exchanged, new values with respect to the total weight and the total costs are automatically calculated again. The data base comprises respective calculating functions such as “performance validation data functions, cost validation data functions, rigidity verification data functions, and weight and weight distribution validation data functions”.

Furthermore, EP 1 770 618 A1 describes that a user can press a “button” whereupon the model with the smallest weight will be selected. A similar method is also indicated with respect to model costs.

US 2005/091010 A1 shows a computer based system for the automatic generation of a 3D model of an aircraft. The authors describe a network of several groups which take part in development, among them a weight team. In FIG. 2, a flow chart of the information and data processing is described, wherein among other things the weight properties of the aircraft are updated.

It is an objective of the invention to inform the designer of an object comprising of a multitude of single parts and subassemblies, in particular an aerospace object such as an aviation or space flight object, to the largest possible extent about the object. Under simultaneous real and virtual product development, the designer shall be enabled to identify necessary changes as early as possible and to make ideal decisions.

### SUMMARY OF THE INVENTION

The problem of the present invention is solved by a computer implemented method, a construction module and a manufacturing system as defined by the claims. Preferred embodiments are subject of the subclaims.

In one aspect, the present invention relates to a computer implemented method for planning an object which comprises a multitude of single parts and subassemblies. The object comprising the multitude of single parts and subassemblies may be an aerospace object. There may exist a time overlap of the construction phase and the production phase of the object. In the construction phase, a data set may be generated for each single part, for each subassembly and for the object. The data sets of each single part and of each subassembly may indicate—as different weight types—a target weight, a calculated weight and a measured weight. In the production phase, real single parts and real subassemblies may be manufactured and weighed.

In accordance with the invention, the total weights of the subassemblies and/or of the object may be calculated on the basis of the data sets of the single parts and the subassemblies. Measured weights may be used preferably to calculated weights, and calculated weights may be used preferably to target weights for the calculation of the total weights of the subassemblies and/or of the object. Information about the shares, fractions or portions of the used weight types with respect to the calculated total weights, may be calculated and provided.

Advantageously, all available data of the single parts and of the subassemblies is used as early as possible. The designer assigned with the design of the whole object or with the design of one or more subassemblies of the object is able to change his construction settings in good time. Therefore, limits on the weights may be kept and possible procurement problems may be discovered at an early stage of the product development.

The early integration of the information of the weight of the real single parts and of the real subassemblies from the production phase leads to the reduction of weight. A possible over-dimensioning of not yet constructed single parts in a running series production can be avoided. This is beneficial in those cases when it is not possible to reproduce the parts with less weight (such as in case of CFRP) or when the costs for the reproduction are too high. For aerospace objects, the reduction in weight is further beneficial because less kerosene may be used, and the saved kerosene itself would no longer be transported during flights. The emerging space can be filled with additional load capacity.

The single parts and the real single parts of the object are not only produced during construction and production phases but also grouped into subassemblies and, if applicable, assembled. A subassembly can itself be a single piece consisting of assembled single parts, or it can comprise a loose set of single parts. A subassembly can exclusively comprise loose single parts. This is the case if the delivery of a group of single parts is specified in the sales contract.

In a computer-implemented planning tool, the subassemblies are typically grouped into a tree structure, the root of the tree being formed by the object itself. The tree structure typically involves several hierarchy levels. For many of the subassemblies and preferably for each subassembly, a data set exists which is generated during the construction phase and which indicates the different weight types in accordance with the invention. The object itself forms the uppermost assembly of the tree structure. In accordance with the invention, the shares of the target weights, calculated weights and measured weights of single parts and of subordinate subassemblies as a part of the total weight of a subassembly or the object (as the uppermost assembly) are calculated and provided.

The information of the shares of the used weight types in the calculated total weight may comprise an indication of numbers and/or percentages, but also graphical representations like functions of time, bar charts or pie charts, from which the information is either directly readable or at least derivable.

In this context, providing information means for example passing the information to an output interface, which may be connected to a display means or to a printer. Providing information can also mean that information is stored in a volatile or non-volatile memory to which other computer facilities or applications have access.

According to the priority rule, the calculation of the total weight of subassemblies or of the object first involves the measured weight of the real constructed single parts, and if this is not available, their calculated weight, and if this is not available either, the target weight or a standard value. The target weight of a single part or subassembly is often given as a kind of guidance or leading line for the design. As a preliminary value during the construction phase, the target value of the single part or of the subassembly can be used for the calculation of the total weight, as long as the single part or the subassembly is not present as a three-dimensional model with a definition of the material density or a respective measured weight.

If there is no target weight and no standard value available, then the respective single part indicates a missing weight. If the missing weight of the single part hinders the calculation of the total weight, then the data set indicates a missing weight for this single part with a reference that this data is required, unless it can be compensated by a known value of the superordinate subassembly to which it belongs.

According to preferred embodiment, every data set comprises a field for the target weight, the calculated weight and the measured weight. Therefore, the data set preferably comprises a vector field, such as an array field, for the weight. The vector field enables the required multiple definition of “weight”.

According to a preferred embodiment, the data set of the object indicates the target weight of the object. Preferably, information about the ratio of the calculated total weight of the object in relation to the target weight of the object is calculated and provided. There may be a coloured accentuation or display of the information if the total weight exceeds the target weight.

Furthermore, information about the ratio of a number of single parts and subassemblies, whose measured or calculated weights are present, in relation to the total number of single parts and subassemblies and/or

information about the ratio of a number of single parts and subassemblies, whose measured weights are present, in relation to the total number of single parts and subassemblies and/or

information about the ratio of the number of single parts and subassemblies, whose measured weights or calculated weights are present, in relation to the number of single parts and subassemblies whose measured weights are present may be calculated and provided.

Furthermore, derivable information can be calculated and provided, such as information about the number of parts and subassemblies whose measured weights are not present. Said information can be provided by the same means as described before.

According to another aspect, the invention provides novel indicators for the stage of maturation of a product/production of a product, so-called KPI (Key Performance Indicators). The novel KPI allow drawing conclusions about important key parameters for reference documentation such as the status of the current implementation with respect to the planned development of the project, the design maturity, the status of feasibility of manufacture by the manufacturer, the status of feasibility of procuration of all required material by the procurer, the status of the total weight and the weight maturity, as well as the status of the total costs and the costs maturity. The novel KPI allow for a maximum transparency of the project and improve the possibilities of external validation of the projects enormously, because the representation of the KPI, e.g. as a historical graph, allows a planning of the future and helps to stop undesirable developments with regard to due date, maturity, weight and costs.

According to the invention, it is advantageous to calculate the total weight of the single parts and subassemblies which are not yet produced as exactly as possible. This allows making early decisions with regard to design changes. Typically, the weight of a single part is calculated on the basis of values which influence the weight of the single part. Those values which influence the value of a single part comprise data regarding the materials, volume, densities and areas of the single part.

Furthermore, according to a preferred embodiment, weight changes can be taken into account, arising from workmanship on parts of or on the whole surface of a single part, in particular by means of paintwork or other forms of surface treatment.

The data sets of the single parts are preferably fed by a construction system for a three-dimensional representation, which may be a CAD application, for instance CATIA, and/or via a management system for product data, in particular a software management system for products, manufacturing processes and inventory, such as SAP and/or via manual entries into the system.

In some cases, the system is able to identify a single part by the data entry of the designer and qualifies it as an available standard single part of a production phase of a completely different object. In such cases, the measured weight of the respective single part may already be known. In some embodiments of the invention, therefore, the construction module integrates this data into the data set of the respective single part and uses this data as the measured weight of the single part.

The weight weighed in the production phase of the real single part or of a real subassembly may be entered manually or it may be automatically fed into the system. The manual entry may typically take place during large scale projects such as aircraft or space flight objects like rockets. However, the data may also be fully automatically determined and fed into the respective data set, for instance by means of a measuring means which, if applicable, may furthermore measure the single part or the subassembly with respect to its spatial dimensions and which transmits the determined data to the construction module, the latter updating the data set accordingly. Furthermore after measuring, the information update in the respective data set may be performed with regard to further weight relevant parameters such as material standard, material alloys and material density and, if applicable, spatial parameters.

In the production phase, the real single parts and/or the real subassemblies are produced according to the data sets. The production/manufacturing may be performed fully automatically, semi automatically or manually. In the production of big aircraft, the data sets are typically converted into technical drawings according to which the production may take place either manually or by machine. A fully automatic production of real single parts and/or subassembly may also take place by applying rapid prototyping, wherein machines which are fed with the data sets automatically take over the production. A fully automatic production may take place as described in EP 0 290 809 B1 or DE 10 2007 015 682 A1 (cited above). Another example which comes from non-aircraft technology is a fully integrated 3D printer with a construction module and a measuring means such as an SLS system (SLM, selective laser melting).

According to a preferred embodiment of the invention, the weight of the subassemblies grouping single parts is used instead of the weights of the respective single parts at the calculation step of the total weights of the subassemblies and/or the object. After its production, a subassembly will be weighed and, if applicable, spatially measured in the same way as described with regard to the single parts. The obtained data will be fed into the respective data set as described above.

When calculating the total weight of the subassemblies and/or the object, the measured weight of a subassembly replaces the weight of the respective single parts allocated in the respective subassembly. However, if the measured weights of single parts within a subordinate are present, then in accordance with the invention, the measured weights of these single parts are used, together with the not yet measured weights of the remaining single parts. In this case, the respective subassembly is not yet considered when calculating the total weight. In doing so, the designer is always provided with the best mature data and can make ideal decisions.

For the subassemblies, essentially the same preferences and statements are valid as given above with regard to the single parts, such as that they may be produced fully automatically, semi automatically or manually and that the measured weights of the subassemblies may be entered manually or be automatically fed into the system. From the information about the ratio of the number of parts in relation to the number of subassemblies, another KPI may be derived, namely a degree of agglomeration of the object.

According to the invention, every measured weight of an assembled subassembly will be preferred to any otherwise calculated weight of the subassembly. In the sense of the present invention, it is beneficial to determine the weight of not yet produced real subassemblies as precisely as possible in order to enable early decisions regarding whether a change in the design will be required. For instance, a subassembly which has been assembled by means of a new technology may feature a totally different weight from when it was planned, and it can be lighter or heavier than with the old technology.

Weight changes due to or arising from the assembly of single parts are taken into account when calculating the total weight of the subassemblies and/or of the object. A preferred approach to this is the following: A data set of a single part defines the topological characteristics of this single part with regard to other single parts. Alternatively or additionally, the data set of the subassembly defines the topological characteristics of the single parts allocated in the subassembly. These topological characteristics in particular may concern the corners, edges and surfaces of single parts connected to or to be connected to respective corners, edges or surfaces of other parts. Furthermore, the data set of the single part or of the subassembly preferably indicates assembly options such that weight changes due to the assembly of single parts may be taken into consideration. The assembly options may be part of the topological characteristics of the single parts or subassemblies. Assembly options may comprise the presence of welded connections, soldered connections, adhesive bond connections, or bolted or riveted connections. Preferably, the data field of the assembly options allows free entry which makes it possible to specify any novel technology, too.

Consequently, the length of assembly lines, such as welding seams, the area of joining areas, the weight of bolts and rivets may be taken into account for the determination of the total weight. Similarly, the free entry for the novel technology is attributed a weight which may also be manually entered. In this way, a novel technology of assembly can be specified in a very uncomplicated manner.

In another aspect, the present invention is directed to a computer implemented construction module, the construction module being executed by a programmable computer means, for supporting the planning of an object which comprises a multitude of single parts and subassemblies, especially an aerospace object. There may be a time overlap of the construction phase and the production phase of the object at the time of manufacture.

The construction module may include a data set for each single part, for each subassembly and for the object, wherein the data sets of each single part and of each subassembly may indicate as different weight types a target weight, a calculated weight and a measured weight.

The construction module may include a means for total weight determination which is configured for, i.e. which includes respective programming instructions for calculating the total weights of the subassemblies and/or of the object on the basis of the data sets of the single parts and the subassemblies.

The means for total weight determination may use measured weights preferably to calculated weights, and calculated weights preferably to target weights for the calculation of the total weights of the subassemblies and/or of the object.

The means for total weight determination may be configured for calculating and providing information about the shares of the used weight types in the calculated total weights.

The construction module preferably includes an update means configured for updating the data sets at least with respect to calculated and measured weights.

Preferably the update means is configured for updating the data sets of the single parts and/or subassemblies with regard to all available data and for identifying, displaying and storing the changes with respect to a latest data status.

The display of the changes with respect to the latest data status and with respect to former data statuses may involve a status display for each single part and/or subassembly, for instance as “deleted”, “new” or “changed”. The changed content of the data set may be highlighted by coloured markings in order to provide a better overview. The display of the changes may be implemented as a comparison providing an overview of all connected single parts and subassemblies at the level of the object as the uppermost subassembly, or as a comparison between different objects. The comparison may involve the out-of-date data with the up-to-date data.

The construction module may generate and manage data sets in order to allow a paperless production without the help of additional two-dimensional reference documentation such as drawings or parts lists.

The construction module may comprise links to one or more construction systems or a three-dimensional representation such as CATIA. The module may import data such as volume, surfaces or dimensions into the data sets of the single parts and subassemblies.

The construction module may additionally or alternatively comprise links to one or more production data management systems such as SAP. The construction module may import data such as released processes, inventory, delivery time or prices into the data sets of the single parts and the subassemblies.

The imported data may be consolidated in the object of the uppermost subassembly for the controlling and optimization of costs and weight, the feasibility of manufacture and the procurement of the material.

The computer implemented construction module preferably includes a module which allows storing links between relevant parameters such as material standard, material alloy, material density or other material characteristics such as rigidity or tensile strength. Preferably, the module allows storing the links or interrelations of the relevant parameters during any first use of a data set, such that the interrelations of parameters are assessable in terms of a search matrix for further data sets. First use means that a single part is newly created by the designer and defined with relevant parameters. The newly created and defined single part will be available to the designer at a second use, i.e. when another single part is created. It may be provided for the second use that the input of a required minimum strength or minimum tensile strength directly leads to a suitable choice of single parts listed in the management software and/or that the input of a material alloy directly leads to a suitable choice of a single part list in the management software.

Furthermore, a given target weight and a minimum strength or minimum tensile strength as the boundary conditions of a given volume of a three-dimensional model and further material data of all materials of all first uses may provide an automatically optimized pre-choice for the designer.

Furthermore, it may be provided that, with a material density linked to a material alloy and to a volume, the weight can be automatically calculated and stored in the data set of the single part via the three-dimensional construction software. Furthermore, it can be provided that an input of a material standard with the automatic adaption of the linked data from the search matrix such as material alloy, material density and material characteristics, may lead to an automatically calculated weight. The calculated weight may be automatically stored in the data set of the single part, e.g. by the three-dimensional construction software.

The computer implemented construction module preferably includes a module for the output of data from the data sets of the single parts, the subassemblies or of the object in the form of a short description with relevant data and, if applicable, with a three-dimensional presentation of the single part or of the subassembly. The module may output the respective data for any person involved in the generation or evaluation of the data sets, such as persons from a design department, a manufacturing department, a purchase department, a weight department, a cost department and the project management department.

All different weight types of the data set, i.e. the measured weight, the calculated weight and the target weight, may be displayed, as well as the percentaged distribution of all weight types with respect to the total weight of a subassembly or of the object. This allows for a weight optimized construction process for single parts and subassemblies.

The cost department preferably receives the differences in costs between the target costs and the calculated costs, calculated on the basis of the processes and materials as defined in the data sets. This allows for a cost optimized construction process for the single parts and the subassemblies.

The manufacturing department receives processes and materials, as well as the result of the manufacturing feasibility check. This allows an optimized construction process for the single parts subassemblies with respect to the feasibility of manufacture.

The purchase department receives the processes and materials, as well as the purchase visibility check on the basis of the data set. This allows an optimized construction process for single parts and subassemblies with respect to the feasibility of purchase.

The project management department receives the KPI curves as functions of time of the percent and of the real amount of created data with regard to the amount of created single parts and subassemblies with respect to design maturity, weight, costs, the feasibility of manufacture and the feasibility of purchase.

The computer implemented construction module preferably includes a module which is configured for automatically informing any person involved in the generation or evaluation of the data sets, in particular persons from the design department, manufacturing department, purchase department, weight department, cost department and project management department, at each change of content of the data sets. The changes may indicate the receipt of a pre-OK of a designer, a pre-OK of an in-house constructor or purchaser, or the moment when the data is transferred into “real” data. The automatic information may involve a communication system for an intranet and/or for the internet such as a program for the sending and receiving of e-mails. Preferably, it is provided that all of these persons may store comments with respect to the content of the data set at any time. Preferably, it is provided that all these persons may send a text such as an e-mail automatically to all involved persons from the design department, production department, purchase department, weight department, cost department and project management department. Furthermore, it is preferably provided that all these persons may store links to files in these data sets, with respect to enclosures and the content of the data sets. Preferably, it is provided that all these persons may automatically send the text of an e-mail to all involved persons.

For the project management department, the computer implemented construction module enables supervision and control with regard to due date as KPI histories which are output in the forms of values and graphs.

The computer implemented construction module may be in the form of a software module, a software routine or a software subroutine. It may be stored on a machine-readable storage medium such as a permanent or rewriteable storage means, or on a storage medium assigned to a computer means, for instance a mobile storage medium such as a CD-ROM, a DVD, a Blu-ray disc, a USB stick or a memory card. Additionally or alternatively, the computer implemented construction module may be provided on a computer means such as a server or a cloud server for download, for example via a data network such as the internet or via a communication line such as a telephone line or a wireless line.

Preferably, the construction module is configured for performing the computer implemented methods as described herein. Therefore, features which have been described in the context of the method are disclosed for the construction module, and, vice versa, features which have been described in the context of the construction module are disclosed for the methods as well.

The units of the construction module, for example the means for total weight determination, the update means and the other described modules may be functional units which are not necessarily physically separated from each other. Several units of the construction module may be realized in the form of a single physical unit, for instance if several functions are implemented in the software. Furthermore, the units of the construction module may be realized as hardware, for example as ASIC (Application Specific Integrated Circuit) or as microcontrollers or in storage units, respectively. Preferably, at least the means for total weight determination and the update means are software implemented in the construction module. Even more preferable, the construction module includes links to one or more of the manufacturing systems as described below.

In another aspect, the present invention is directed to a manufacturing system for manufacturing an object which comprises a multitude of single parts, especially an aerospace object, wherein the manufacturing system comprises a programmable computer means including a construction module as described above.

Preferably, the manufacturing system includes a measuring means. The measuring means may at least be configured for weighing real single parts and real subassemblies and for presenting the measured weights digitally or analogously to the user and/or for feeding the measured values or data back into the programmable computer means, in particular into the computer implemented construction module.

The update means may be configured for updating the data sets of the single parts and/or of the subassemblies with respect to the measured weights of the real produced single parts and/or subassemblies. The update means may receive the measured values or data from the measuring means digitally or may receive the input data manually. After successfully updating the data set, the update means may cause the means for total weight determination to update the data sets at least with respect to the calculated and the measured weights of the single parts and subassemblies. During that update process, all further data may be updated and the changes may be displayed.

The measuring means is preferably configured for determining further data, in particular spatial parameters, i.e. the three-dimensional volume of the real produced single parts and/or subassemblies, and for displaying the same in the same way as the weight to the user or for feeding these back to the programmable computer means.

The update means may be configured for updating the data sets of the single parts and/or subassemblies with respect to the further data provided by the measuring means.

According to a preferred embodiment, the manufacturing system includes a production means. The production means may produce real single parts and real subassemblies on the basis of respective data sets. The production means may provide the real produced single parts and subassemblies to the measuring means. In some embodiments, the measuring means may be integrated into the production means.

According to a preferred embodiment, the manufacturing system includes an assembling means. The assembling means may assemble the real produced single parts to subassemblies and/or several subassemblies to higher ranked, i.e. superordinate subassemblies. In some embodiments, the measuring means may be integrated into the assembling means. Furthermore, in some embodiments, the measuring means, the production means and the assembling means may be integrated into a superior installation.

The update process of the measuring means and the update means is preferably repeated after each process step in which the single parts are assembled to subassemblies.

### BRIEF DESCRIPTION OF THE FIGURES

Exemplary embodiments of the invention are depicted in the following figures. The exemplary embodiments are not to be understood as limiting the invention. The person of skill in the art will readily be aware of a multitude of modifications which are in the spirit and scope of the present set of claims.

FIG. 1 shows a manufacturing system in accordance with the invention,

FIG. 2 shows a flow chart depicting working processes in the construction phase of an object and

FIGS. 3-5 show diagrams depicting the degrees of maturity of an object.

### DETAILED DESCRIPTION OF THE FIGURES

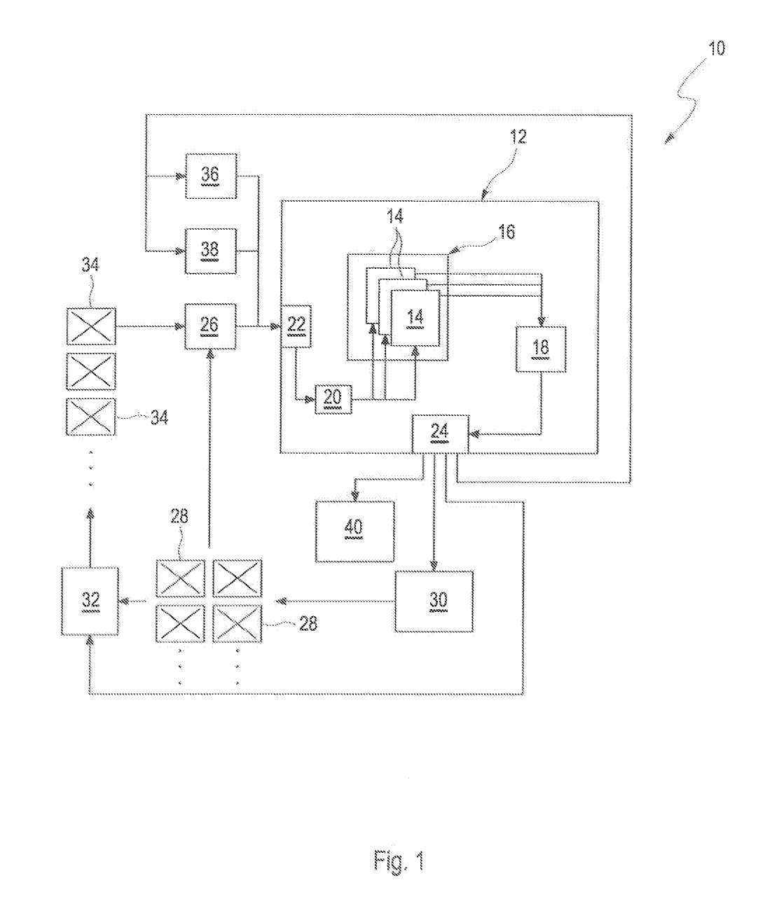

FIG. 1 shows a manufacturing system 10 with a programmable computer means 12, a measuring means 26, a production means 30 and an assembling means 32.

The manufacturing system 10 allows for the manufacturing of an object which is composed of a multitude of single parts and subassemblies, for example single parts of an aerospace object such as an aviation object or space flight object.

The programmable computer means 12 can be any computer means which substantially includes at least a processor with an internal memory such as RAM (Random Access Memory), which allows for storing and executing instructions. The programmable computer means 12 may include well-known server client technology and/or cloud technology as well as industry computers, personal computers, smart phones, tablets or the like.

The programmable computer means 12 includes a non-volatile storage means 16, for instance a ROM (Read Only Memory) in which data sets 14 are stored for the single parts, the subassemblies and for the object.

The data sets 14 of the single parts and subassemblies include data with respect to spatial parameters, in particular volume, area or surface, topological characteristics of the single parts and subassemblies with respect to each other, and assembly options such as welded connections, soldered connections, bolt and rivet connections, glued or adhesive bond connections and indications regarding material, density and weight.

The programmable computer means 12 includes an input interface 22 via which the data sets 14 may be created and via which a weight, weighed in the production phase of a real produced single part 28 or of a real produced subassembly 34, may be entered into the respective data set 14. It is possible that the data sets may be fed via input interface 22 through a construction system for a three-dimensional representation 36 such as CATIA and/or through a production data management system 38 such as SAP and/or by manual input.

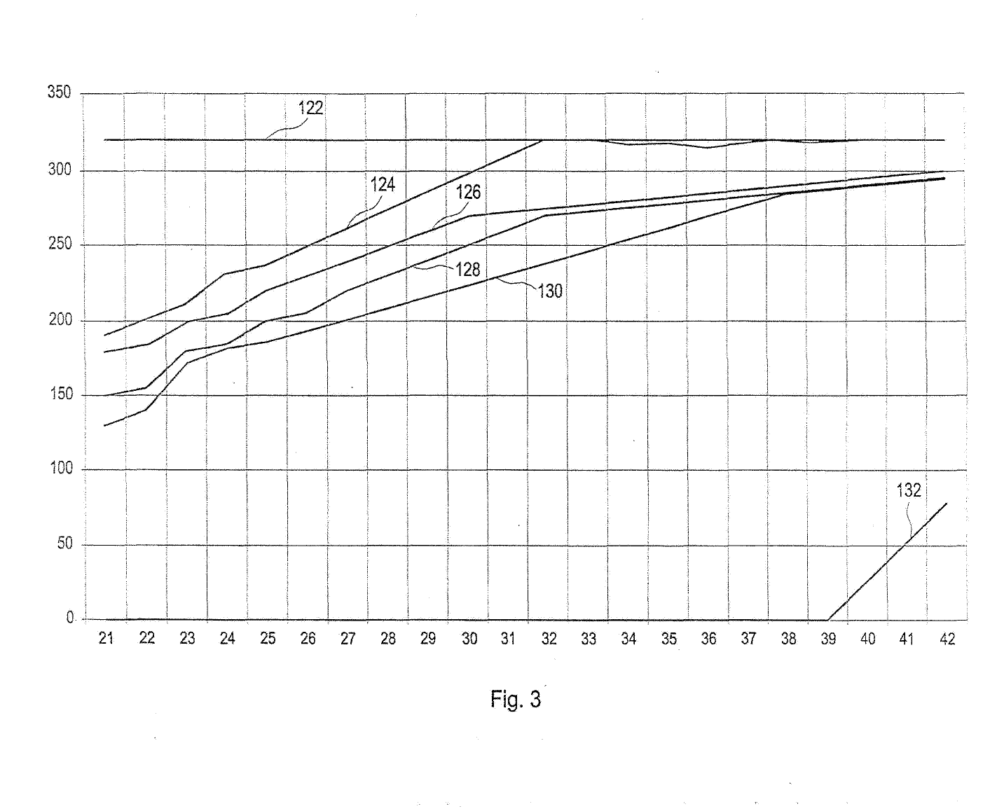

Furthermore, the programmable computer means 12 includes an output interface 24 which may be coupled to display means or printers (not depicted) and via which information from the data sets 14 may be presented, for example information which will be described with respect to FIGS. 3 to 5. The display devices may also produce elevations, in particular 3D elevations, of the single parts, subassemblies and of the whole object. In particular, some automatic representations of single data sets 14 in the form of a short description with all relevant data and comprising a picture of a three-dimensional elevation of the single part, the subassembly or the whole object may be given via the output interface 24. The output interface 24 may also comprise links to the construction system for the three-dimensional representation 36 and/or to the production data management system 38. Therefore, data such as volume, surface, dimensions, as well as released processes, inventory, production times and prices may be transferred from the data sets 14 of the single parts and subassemblies into these systems 36, 38.

Furthermore, there can be links to a communication system 40 for an intranet and/or the internet such as a program for the sending and receiving of e-mails realized via output interface 24. This allows a feedback on the evaluations for the optimization of a construction of the single parts or subassemblies with respect to the feasibility of manufacture and the feasibility of purchase in an early phase of development.

The computer means 12 includes a means for total weight determination 18 which is configured for calculating the total weights 152 of subassemblies or of the object on the basis of the indicated weights of the single parts and subassemblies as indicated in the data sets 14. The means for total weight determination 18 uses the measured weights preferably to the calculated weights, and the calculated weights preferably to the target weights in the course of its calculation of the total weight 152 of subassemblies or of the object. The means for total weight determination 18 calculates information about the shares of the used weight types in the calculated total weights and information about the ratio of the calculated total weight of the object in relation to the target weight of the object, as well as further KPI as described above. The means for total weight determination 18 provides the calculated information to the output interface 24.

The manufacturing system 10 includes a production means 30 which receives data from the output interface 24 and which produces real single parts 28 on the basis of the received data. The production may comprise selective laser melting, cutting or chipping, deep drawing, casting, turning or the like. This process step of producing/manufacturing may be performed fully automatically, for instance through the evaluation of the data set 14, provided to the production means 30 via output interface 24.

The manufacturing system 10, furthermore comprises an assembling means 32 which is configured for assembling real single parts 28 to real subassemblies 34. The assembling process step may be fully automatically, for instance through the evaluation of the data sets 14 provided to the assembling means 32 via output interface 24. The assembling means 32 may also assemble real subassemblies 34 to superordinate subassemblies.

The manufacturing system 10 includes a measuring means 26 which is configured for weighing the real single parts 28 and the real subassemblies 34 and for providing the determined weights directly or indirectly to the computer means 12 via input interface 22. The measuring means 26 may furthermore be configured for determining and providing further characteristics such as the dimensions or the colour of the real single parts 28 and the real subassemblies 34 to the computer means 12 via input interface 22.

The computer means 12 includes an update means 20 which is configured for updating the data sets 14 of the single parts and/or subassemblies with regard to weights and, if applicable, dimensions, colour and the like. The update means 20 is connected to the input interface 22 in order to receive the respective data and to process the input data. In some (not depicted) embodiments, the update means 20 may directly communicate with the output interface 24 and may generate representations of data with the indications of changes with regard to the former data statuses of the data sets 14.

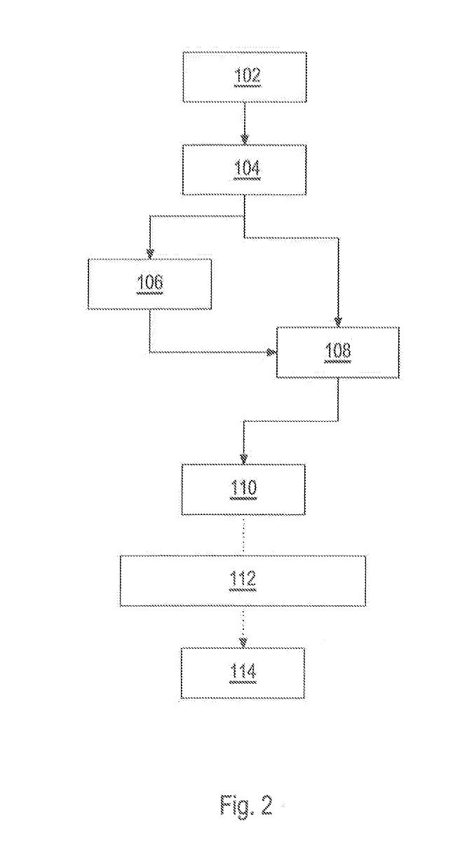

FIG. 2 shows a typical work progress in the construction phase of a single part belonging to an object which is comprised of a multitude of single parts.

In the manufacture of the single parts, subassemblies and the object, several persons are typically involved, among who there may be a designer, a manufacturer, a purchaser from a design department, manufacturing department, purchase department, respectively. It is clear that these persons do not need to be real persons and that the actions of these persons do not necessarily need to be attributed to real persons but may also run semi automatically or fully automatically through respective means.

The construction phase of a single part may be connected to the construction of the object as follows: At first, a data set 14 is created with respect to an uppermost assembly which is the object to be created. The object is attributed the target weight, according to the purchase order. The object is subdivided into a number of primary subassemblies which may have, as a pre-setting or guidance of the design, a certain target weight. These primary subassemblies may further be subdivided into secondary subassemblies to which target weights may be attributed, accordingly. The secondary subassemblies may be subdivided into further subassemblies and so on until single parts are to be designed. The construction of the whole object typically involves a team of designers. Every designer is attributed the planning of one or more subassemblies with a target weight as a guide value for his design. The designer will construct the sub-subassemblies and the single parts of these subassemblies. The manufacturing process depicted and described in the following, as the construction phase of a single part, is analogously applied in the planning of subassemblies of the object composed of a multitude of single parts.

The construction phase of a single part starts in a step 102 with the generation of a design of a single part by a designer. In a step 104, the designer gives his OK for a pre-check of this single part. The specification of the designer may not only comprise the spatial parameters and indications for the material and the density, but may also comprise manufacturing instructions such as a specification of the process of manufacture or instructions or statements with respect to costs. The designer may already know at this stage whether the single part can be manufactured by an in-house manufacturer or whether it has to be purchased from an external source. This results for example from his design instructions. In case a process such as turning, casting or the like cannot be performed by an in-house manufacturer, this information is typically specified in the construction module and will be displayed to the designer. In the event that this single part may be manufactured by the in-house manufacturer, the in-house manufacturer will be involved in the following process, otherwise this applies to a purchaser.

In a step 106, the in-house manufacturer gives his pre-OK, if the single part may be manufactured in accordance with the instructions of the designer, especially if this is also possible in the anticipated cost frame. Otherwise, the designer will typically be asked to change his specification and the process will return to step 104.

In a step 108, the purchaser gives his pre-OK if the single part may be purchased in accordance with the instructions of the designer. Otherwise, the designer will be asked to change his specification and the process will return to step 104. If the pre-OK of the in-house manufacturer in step 106 is already there, then the purchaser does not necessarily have to do anything at this stage. However, the pre-OK of the purchaser may also serve for the documentation of the project and for the issuance of KPI which will be explained with regard to the FIGS. 3 to 5 more in detail.

In a step 110, the designer gives his OK. At this point of time, the purchaser and the in-house manufacturer may assume with a high probability that for instance raw material, norm parts or standard parts may be procured for the single part in question, such that the manufacturing may be ordered or that manufacturing helping means such as deep drawing tools or casting forms may be ordered.

The process involving the steps 102 to 110 is performed in parallel for each single part and for each subassembly belonging to the object comprising a multitude of single parts and subassemblies. At a step 114, the virtual data of the single part or the subassembly is transformed into real data. However, in an intermediate step 112 a degree of maturity of the object may be output at any time. The degree of maturity may in particular comprise the KPI as described with regard to the FIGS. 3 to 5 in the following.

At the point of time of step 114, a real single part 28 is present and its measured weight will be provided to the designer. The real single part 28 may be weighed by the measuring means 26.

FIG. 3 shows a first diagram for depicting a degree of maturity of an object as a function of time. The degree of maturity of the object is depicted over a period starting from the 21st week and stopping at the 42nd week. This is purely exemplary.

The first curve shows a total number 122 of single parts and subassemblies which compose the object to be designed. For the present example, the object consists of ca. 320 single parts and subassemblies.

The second curve shows a number 124 of those single parts and subassemblies, for which the designer has given his OK for a pre-check in step 104. While at the beginning there have not been more than 200 single parts and subassemblies in this state, after 32 weeks the status has been reached by the total number 122 of the single part and subassemblies.

Below the curve with the number 124 of those single parts and subassemblies for which the designer has given his OK for a pre-check, another curve is depicted which represents the number 126 of those single parts and subassemblies for which the manufacturer has given his pre-OK in step 106.

Below the curve with the number 126 of those elements and subassemblies for which the manufacturer has given his pre-OK, another curve is depicted which shows the number 128 of those single parts and subassemblies for which the purchaser has given his pre-OK in step 108.

Below the curve with the number 128 of those single parts and subassemblies for which the purchaser has given his pre-OK, there is another curve showing a number 130 of those single parts and subassemblies for which the designer has given his OK in step 110.

Below the curve with the number 130 of those single parts and subassemblies for which the designer has given his OK, there is another curve which shows a number 132 of those single parts and subassemblies for which the transformation of the virtual data of the single part or subassembly to real data has happened in step 114. At this step, the data set 14 in particular includes a measured weight.

With the strict compliance of the principle as described with regard to FIG. 2, the curves 122, 124, 126, 128, 130 and 132 will touch each other but do not intersect.

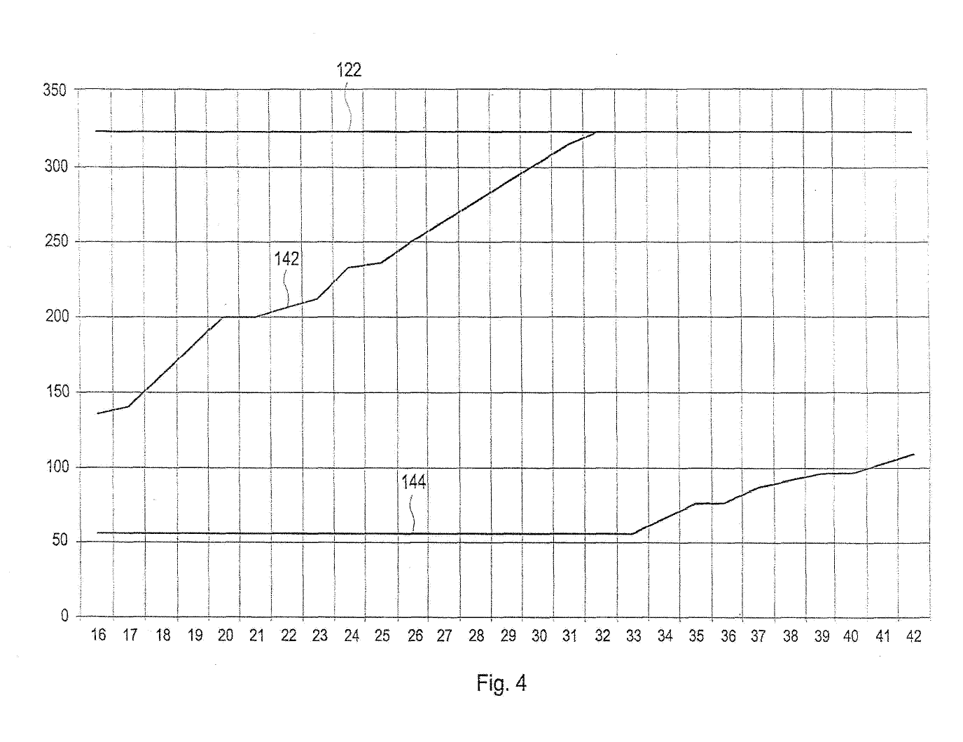

FIG. 4 shows another diagram depicting the degree of maturity of an object as a function of time, in particular the development of the weight as a KPI for the degree of maturity of the object. The same example as in FIG. 3 comprising 320 single parts and subassemblies is depicted. The time frame comprises exemplarily the weeks 16 to 42.

A first curve shows again the total number 122 of single parts and subassemblies building the object to be produced.

A second curve shows a number 142 those single parts and subassemblies whose data set 14 indicates the measured or the calculated weight. For these single parts and subassemblies the measured weight or the calculated weight is available in the construction module. Consequently, these single parts or subassemblies are not necessarily real single parts 28 or real subassemblies 34 in the sense of the invention.

A third curve shows a number 144 of those single parts and subassemblies, whose data set 14 indicates the measured weight. The information does not include the real single parts 28 or the real subassemblies 34 which have been weighed for instance by the measuring means 26, but it also includes standard parts from former projects which are already present in the construction module with their measured weight. As a besides, the discrepancy to the curve in FIG. 3 which shows the number 132 of those single parts and subassemblies which in step 114 the transformation of the virtual data of the single part or the subassembly to real data has happened is explained by this fact.

The scenario as depicted in FIG. 4 may be transferred to costs as a KPI for the degree of maturity of an object. In this context, one curve will show those single parts and subassemblies for which real costs are known after production or for which guess values are present. Another curve will show the number of those single parts or subassemblies for which the real costs are known.

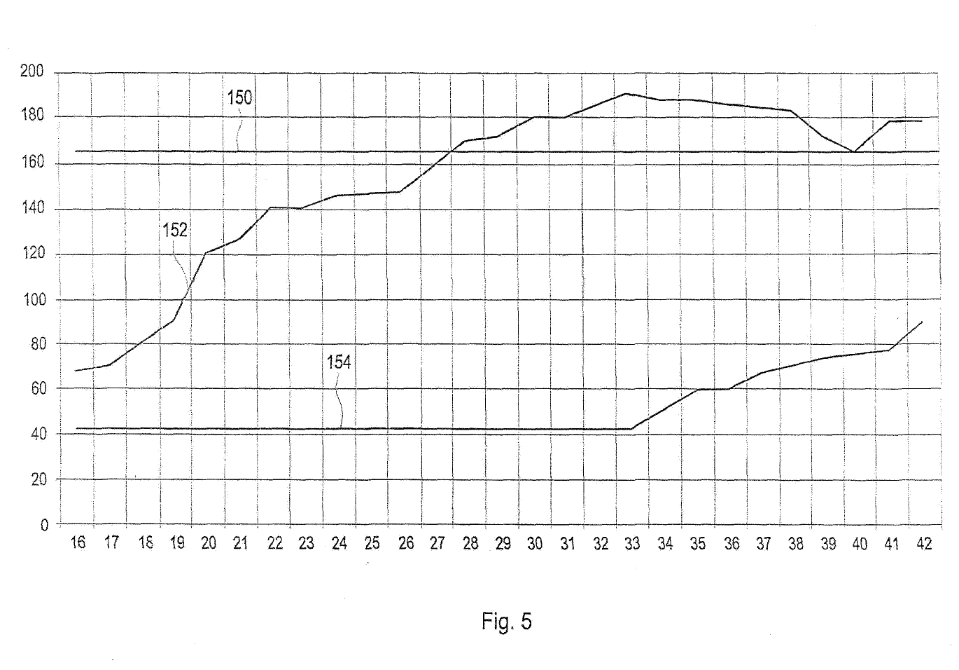

FIG. 5 refers to the example of FIGS. 3 and 4 and depicts a target weight 150 of the object, a total weight 152 of the object and a total weight 154 of the real single parts 28 and real subassemblies 34 of the considered object from week 16 to week 42.

The total weight 152 of the object will be formed by the measured weight, the calculated weight and the target weight of the single parts and the subassemblies, according to the described priority rule that first the measured weights of the real single parts 28 and the real subassemblies 34 is used and, if not existent, the calculated weight is used and, if not existent, the target weight or a standard value is used. As described above, the measured weight of each real single part 28 will be preferred to the weight of a subassembly comprising this real single part until a real subassembly 34 is present which comprises the real single part 28. Inversely, if a real subassembly 34 is there, then the information about the inferior subassemblies and single parts comprised in the real subassembly 34 is not considered anymore.

One may read from FIG. 5 the information about the ratio of the total weight 154 of the real single parts 28 and the real subassemblies 34 in relation to the total weight 152 of the object as a KPI for any point time. Furthermore one can read from FIG. 5 the information about the ratio of this total weight 154 of the real single parts 28 and the real subassemblies 34 in relation to the target weight 150 of the object, as well as the information about the ratio of the total weight 152 of the object to the target weight 150 of the object.

In FIG. 5, the total weight 152 of the object exceeds the target weight 150 of the object at the 28th day. A minor excess of the target weight 150 of the object is not accepted in most cases at the end of the project such that the designer has to accept restrictions when constructing novel single parts or subassemblies and has to change existing designs of single parts or subassemblies. With the help of the invention, this situation is efficiently counteracted.

1. A computer implemented method for planning an object which comprises a multitude of single parts and subassemblies, especially an aerospace object,
wherein a time overlap of the construction phase and the production phase of the object is present,
wherein, in the construction phase, for each single part, for each subassembly and for the object, a data set is created,
wherein the data sets of each single part and each subassembly indicate, as different weight types, a target weight, a calculated weight and a measured weight,
wherein, in the production phase, real single parts and real subassemblies are manufactured and weighed,
the method comprising:
calculating the total weights of the subassemblies and/or of the object on the basis of the data sets of the single parts and the subassemblies,
wherein measured weights are used preferably to calculated weights, and calculated weights are used preferably to target weights for the calculation of the total weights of the subassemblies and/or of the object, and
calculating and providing the information about the shares of the used weight types in the calculated total weights.

2. The method of claim 1, wherein the data set of the object indicates a target weight of the object and wherein information about the ratio of the calculated total weight of the object in relation to the target weight of the object is calculated and provided.

3. The method of claim 1, wherein
information about the ratio of a number of single parts and subassemblies, whose measured or calculated weights are present, in relation to the total number of single parts and subassemblies and/or
information about the ratio of a number of single parts and subassemblies, whose measured weights are present, in relation to the total number of single parts and subassemblies and/or
information about the ratio of the number of single parts and subassemblies, whose measured weights or calculated weights are present, in relation to the number of the single parts and subassemblies whose measured weights are present
is calculated and provided.

4. The method of claim 1, wherein the measured weights of real single parts or real subassemblies are entered manually or are automatically fed into the system.

5. The method of claim 1, wherein, in the production phase, the real single parts and/or the real subassemblies are fully automatically, semi automatically or manually manufactured on the basis of the data sets.

6. The method of claim 1, wherein, at the calculation step of the total weights of the subassemblies and/or of the object, the weight of subassemblies grouping single parts is used instead of the weights of the respective single parts.

7. The method of claim 1, wherein, at the calculation step of the total weight of the subassemblies and/or of the object, weight changes due to the assembly of single parts being taken into account.

8. A construction module, executed by a programmable computer means, for supporting the planning of an object which comprises a multitude of single parts and subassemblies, especially an aerospace object,
wherein a time overlap of the construction phase and the production phase of the object is present,
wherein the construction module includes
a data set for each single part, each subassembly and for the object,
wherein the data sets of each single part and each subassembly indicate, as different weight types, a target weight, a calculated weight and a measured weight,
a means for total weight determination which is configured for calculating the total weights of the subassemblies and/or of the object on the basis of the data sets of the single parts and the subassemblies,
wherein the means for total weight determination uses measured weights preferably to calculated weights, and calculated weights preferably to target weights for the calculation of the total weights of the subassemblies and/or of the object, and wherein
the means for total weight determination is configured for calculating and providing information about the shares of the used weight types in the calculated total weights.

9. The module of claim 8, including an update means configured for updating the data sets at least with respect to calculated and measured weights.

10. The module of claim 8, with links to one or more construction systems for a 3D representation and/or with links to one or more production data management systems, whose data may be integrated into the data sets.

11. The module of claim 8, including another module allowing for storing the interrelations of parameters during any first use of a data set, such that the interrelations of parameters are assessable in terms of a search matrix when creating further data sets.

12. The module of claim 8, including another module which is configured for the output of data from the data sets of the single parts, subassemblies or from the object in the form of a short description with relevant data for any person involved in the generation or evaluation of the data sets.

13. The module of claim 8, comprising another module configured for automatically informing any person involved in the generation or evaluation of the data sets at each change of content of the data sets via a communication system for an intranet and/or the internet.

14. A manufacturing system for manufacturing an object which comprises a multitude of single parts, especially an aerospace object, comprising a programmable computer means including a construction module according to claim 8.

15. The manufacturing system of claim 14,
including a measuring means configured for weighing real single parts and real subassemblies and/or
including a production means which is configured for manufacturing real single parts or real subassemblies on the basis of respective data sets and/or
including an assembling means configured for assembling real parts to real subassemblies and/or several real subassemblies to superordinate real subassemblies.
